(19) United States
(12) Patent Application Publication
(10) Pub. No.: US 2011/0304295 A1
(43) Pub. Date: Dec. 15, 2011

(54) POWER SYSTEM FOR USE WITH RENEWABLE ENERGY SOURCES AND THE POWER GRID

(76) Inventor: Mark McNally, Guelph (CA)

(21) Appl. No.: 12/797,135

(22) Filed: Jun. 9, 2010

(51) Int. Cl. H01M 10/46; H02J 7/04; H02J 7/00

(52) U.S. Cl. 320/101; 320/107; 320/162

(57) ABSTRACT

A power system is provided, where a load may be powered either by a battery or a source of AC power. The output of the battery (through and inverter) and the source of AC power are both connected to the input of a toggle switch. The output of the toggle switch is connected to the load, such that only one of the battery or the source of AC power is connected to power the load. The battery can be charged from at least one source of renewable energy, and from the output of an AC charger that has, as its input, the source of AC power. The power system has a clock that can be programmed to indicate when a time is peak or off-peak for the source of AC power. The charge level of the battery is monitored by a state of charge monitor. Depending on the state of charge of the battery, and whether the time is peak or off-peak, a controller will output a control signal to the toggle switch to select whether the load is powered by the battery or the source of AC power, and a control signal to connect or disconnect the AC charger.

### BACKGROUND

This invention relates to a system and method for powering a load.

Renewable energy sources have been used to provide power to lessen the demands on an electrical power grid; to provide power as a back-up to an overloaded grid that may experience blackouts or brownouts; to provide power to parts of the world where a grid infrastructure is unavailable; and where the grid cannot be extended due to prohibitive costs. Renewable energy sources have also been used to generate power that can be sold back to the grid.

A known approach to easing the demand on the grid is load shifting which involves storing electricity generated during off-peak periods (such as between 11 p.m. and 6 a.m.) in a battery (or other rechargeable DC source), and discharging the battery to power various loads during peak periods (such as between 6 a.m. to 11 p.m.). U.S. Pat. No. 6,455,954 issued to Dailey and U.S. Pat. No. 6,680,547, also issued to Dailey disclose the use of renewable energy sources in load shifting. In Dailey's systems, when line voltage is available, the battery is charged during off-peak periods, and is discharged to power a load (i) during peak periods, and (ii) if the line voltage is inadequate during an off-peak period (such as due to a black-out).

There remains a need for an improved approach to the use of renewable energy sources.

### SUMMARY

The present invention is directed to an apparatus and a method that satisfies the need for an improved approach to the use of renewable energy sources.

In accordance to the present invention, there is provided a system for powering a load, comprising: a battery; a DC input to said battery for connection to a source of renewable DC power for charging said battery; an AC charger with a DC output connected to a DC input to said battery for charging said battery and an AC input for connection to a source of AC power; a state of charge monitor for monitoring a state of charge of said battery; a clock; a toggle switch for connecting one and only one of said battery and said source of AC power to said load; one of an AC to DC converter connected between said source of AC power and said toggle switch and a DC to AC converter connected between said battery and said toggle switch; a controller input by said state of charge monitor and said clock and outputting a switch control signal to said toggle switch and a control signal to said AC charger; said controller for, on determining said clock indicates an off-peak time for said source of AC power, controlling said toggle switch to switch in said source of AC power and to switch out said battery only if said state of charge of said battery is below a threshold value.

In accordance to another aspect of the invention, there is provided a method of powering a load, comprising: charging a battery from at least one renewable DC power source; powering a load with said battery; monitoring a state of charge of said battery; at a beginning of each off-peak time for an electrical grid, switching in a source of AC power to power said load and ceasing to power said load with said battery only if said state of charge of said battery is below a threshold value.

These and other features, aspects, and advantages of the present invention will become better understood with reference to the following description in conjunction with the drawings.

### BRIEF DESCRIPTION OF THE DRAWINGS

In the figures which illustrate example embodiments of the invention:

FIG. 1 is a schematic diagram of the power system made in accordance with this invention;

FIG. 2 is a state diagram illustrating the operation of a first embodiment of the present invention;

FIG. 3 is a state diagram illustrating the operation of a second embodiment of the present invention;

FIG. 4 is a perspective view of a mobile power system made in accordance with an aspect of this invention, viewed from the input side; and

FIG. 5 is a perspective view of the mobile power system of FIG. 4, viewed from the output side.

### DESCRIPTION

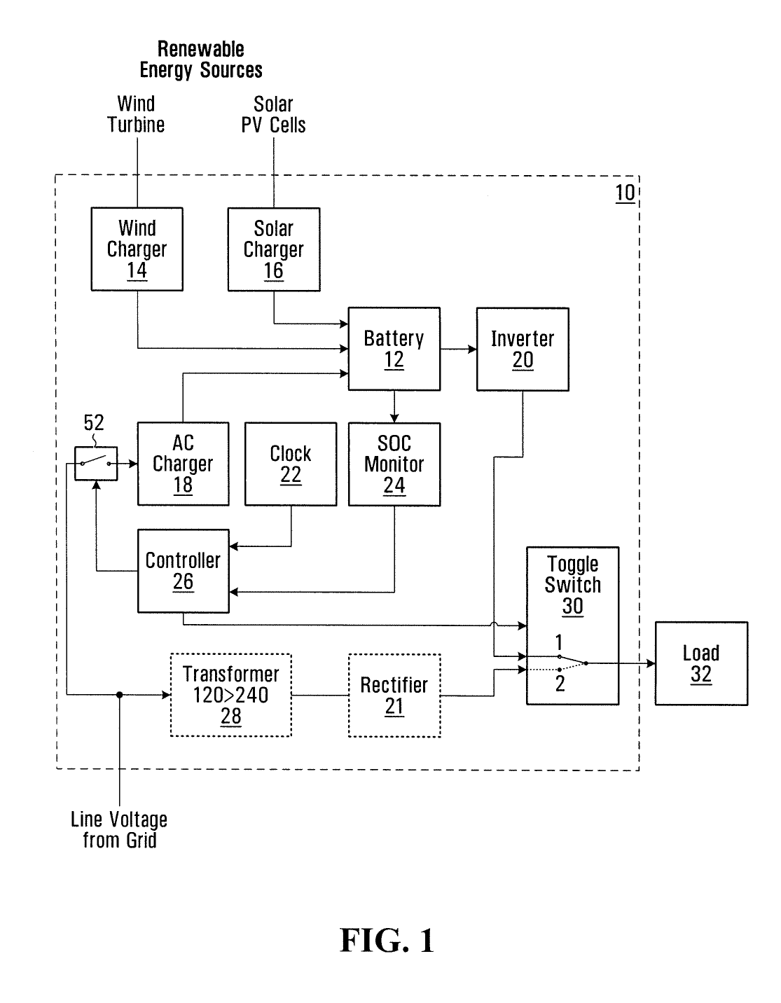

Referring to FIG. 1, a power system 10 receives power generated by renewable energy sources (green power) and from the grid, and provides power to a load 32.

Power system 10 has a wind charger 14 which may be input with the output of one or more wind turbines and a solar charger 16 which may be input with the output of one or more solar panels. The outputs of the wind charger 14 and solar charger 16 input the charging input of rechargeable battery 12.

Wind charger 14 and solar charger 16 condition the power generated by the wind turbines and the solar panels, respectively, so that the power generated is compatible with the input required by battery 12. Solar charger 16 may use maximum power point tracking technology (MPPT) to improve the power generating efficiency of the solar panels. MPPT is an electronic tracking method wherein the power output of the solar panels is compared to the battery voltage, which varies depending on the state of charge. The power output of the solar panels then is converted to an appropriate voltage to ensure maximum current input for charging the battery 12. MPPT therefore allows solar charger 16 to extract maximum power from the solar panels by varying the voltage and current extracted from the solar panels as battery 12 charges. MPPT may also be used in conjunction with wind charger 14.

Battery 12 may be a bank of rechargeable batteries such as Advanced AGM (absorbed glass mat) batteries.

Power system 10 has a switch 52 coupled to line voltage input from the grid. The switch 52 outputs to an AC charger 18; output of AC charger 18 inputs the charging input of battery 12. A suitable AC charger is a high efficiency, 1 kW AC charger supplied by Delta Q Technologies. The line voltage from the grid also connects to input “2” of a toggle switch 30, optionally through a step-down transformer 28. Battery 12 outputs to inverter 20 which is a DC to AC converter for converting the direct current from the battery to alternating current. The inverter may be a heavy duty, quasi sine-wave inverter or pure sine-wave inverter. The inverter outputs to input “1” of toggle switch 30.

A load 32 is coupled to the output of toggle switch 30 to draw AC power from battery 12 and inverter 20 when toggle switch 30 is set to position “1” and from line voltage from the grid when toggle switch 30 is set to position “2”.

A controller 26 is input by a clock 22 and a state of charge (SOC) monitor 24. The controller outputs control signals to switch 52 and toggle switch 30. The SOC monitor 24 is input by battery 12. Although the SOC monitor 24 is shown as a stand-alone component, it could instead be part of the wind charger 14, the solar charger 16, or the inverter 20. The controller 26 may be a separate component or part of the AC charger. The controller can be a programmed mircoprocessor or a field programmable gate array. As will be appreciated by those skilled in the art, it could also be a hard-wired analog circuit.

Power system 10 is configured to use renewable energy sources as the primary source of power for load 32 and rely on the line voltage from the grid to power load 32 only as a back-up when the power generated from renewable energy sources is insufficient. Power system 10 also has load shifting capabilities to cause battery 12 to recharge during off-peak periods, and discharge during expensive peak periods to provide power to load 32. Load shifting is particularly beneficial in parts of the world that experience frequent black-outs during peak periods as a result of the high demand on grid power during that time, such as California and countries in the Middle East. By charging battery 12 during off-peak periods and discharging battery 12 during peak periods, power system 10 can serve to lessen the overall demand on the grid. Further, load shifting can provide economic benefits to the user as more jurisdictions move towards time-of-use pricing. By allowing the user to program peak versus off-peak times on clock 22, the power system 10 allows the user to take advantage of cheaper electricity by charging battery 12 during off-peak periods, and connecting battery 12 to power load 32 during peak periods to reduce the amount of electricity drawn from the grid at a more expensive rate.

Power system 10 accomplishes load shifting with controller 26 which sends output signals to control the operation of switch 52 (which connects in AC charger 18), and toggle switch 30, based on input signals received from clock 22, and SOC monitor 24. The SOC monitor 24 continuously monitors the charge levels of battery 12. Clock 22 is programmable and allows the user to set peak and off-peak times to correspond to the times of the day and the week during which the usage demand on the grid are high and low, respectively. Controller 26 controls whether load 32 is powered by battery 12 or line voltage, and whether the battery 12 is recharged from line voltage.

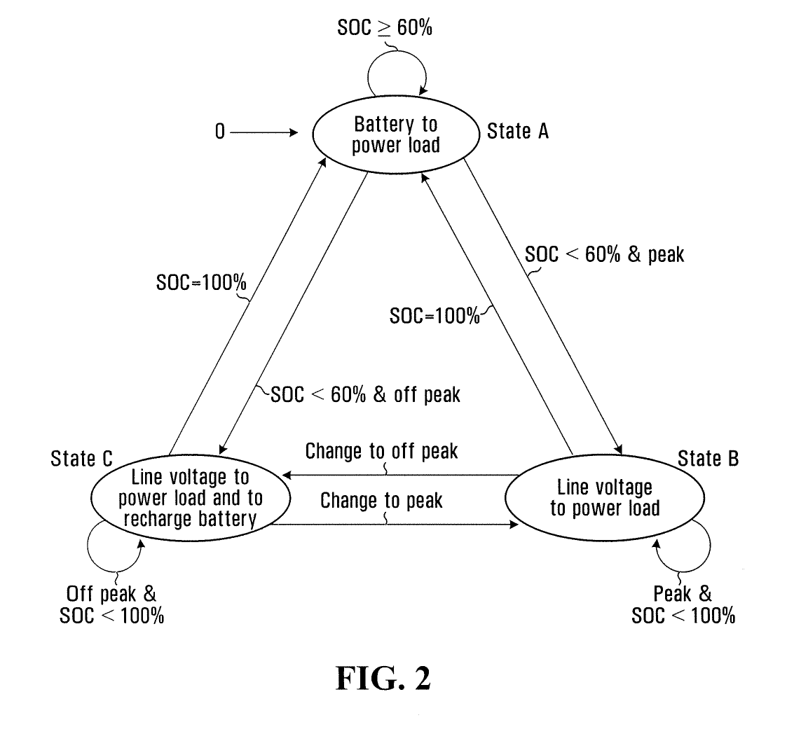

Turning to FIG. 2, in one embodiment of the load shifting aspect of this invention, three states are shown: State A where the battery 12 is providing power to load 32; State B where line voltage is providing power to load 32; and State C where line voltage is providing power both to load 32 and battery 12 simultaneously. Upon powering up, power system 10 will enter State A if the SOC of battery 12 is at 60% or more of full charge as indicated by SOC monitor 24, State B if the SOC of battery 12 is below 60% of full charge and the time is peak, and State C if the SOC of battery 12 is below 60% of full charge and the time is off-peak.

Assuming power system 10 is currently in State A, the system 10 will remain in State A and the battery 12 will power load 32 as long as the SOC of battery 12 remains at 60% or more of full charge, as indicated by the SOC monitor 24. However, if the SOC of battery 12 drops below 60% of full charge, power system 10 will change its state: if the time is a peak time, power system 10 will change to State B such that line voltage supplies power to load 32, and the battery 12 is disconnected from load 32; if the time is off-peak, power system 10 will change to State C such that line voltage supplies power to load 32 and to charge battery 12 simultaneously, and battery 12 is disconnected from load 32. The power system 10 will exit State B or State C when the SOC of battery 12 reaches 100%, at which time power system 10 will return to State A. However, if power system 10 is in State B and the SOC of battery 12 remained below 100%, if the time as programmed on clock 22 changes from a peak time to a non-peak time, power system 10 will change from State B to State C so that line voltage will power load 32 and charge battery 12 simultaneously. Similarly, if power system 10 is in State C and the SOC of the battery 12 remains below 100%, if the time as programmed on clock 22 changes from a non-peak time to a peak time, power system 10 will change from State C to State B such that line voltage will continue to supply power to load 32, but will cease charging battery 12.

To further illustrate how power system 10 gives effect to the changes in states as described above, referring to FIGS. 1 and 2, if power system 10 moves to State A because the SOC of battery 12 reaches 100% of its full charge, controller 26 will send an output signal to toggle switch 30 to switch toggle switch 30 to position “1”, which in turn connects battery 12 to provide power to load 32. If the SOC of battery 12 thereafter drops below 60% of its full charge, controller 26 will switch toggle switch 30 to position “2”, which will disconnect the battery 12 from load 32, and cause the line voltage from the grid to be supplied to load 32 (i.e. changing from State A to either of State B or State C).

Controller 26 controls switch 52 to connect AC charger 18 to battery 12 if clock 22 indicates an off-peak period and the SOC of the battery 12 is less than 60% (i.e. State C). If clock 22 indicates a peak period, the switch 52 will remain open so that the battery 12 does not place a demand on the grid (i.e. State B). However, if during a time when SOC monitor 24 indicates that the SOC of battery 12 is below 60%, such that controller 26 has connected line voltage from the grid to power load 32 by switching toggle switch 30 to position “2”, and the time of day changes from peak to off-peak, controller 26 will also cause switch 52 to connect AC charger 18 to supply line voltage from the grid to charge battery 12 (i.e. changing from State B to State C). Similarly, in the opposite scenario, where controller 26 has switched toggle switch 30 to position “2” to connect line voltage from the grid to provide power to load 32 and AC charger 18 is connected to charge battery 12, if the time of day changes from “off-peak” to “peak”, controller 26 will cause switch 52 to disconnect AC charger 18 so that battery 12 will no longer be charged by the grid during a peak period (i.e. changing from State C to State B). In this way, battery 12 will be charged by the line voltage from the grid only during off-peak periods, and never during peak periods to add to the demands on the grid.

If SOC monitor 24 indicates that battery 12 has reached 100% of its full charge during a “peak” period, controller 26 will cause toggle switch 30 to switch from position “2” to position “1” to disengage line voltage, and connect battery 12 to power load 32 (i.e. changing from State B to State A). Similarly, if SOC monitor 24 indicates that battery 12 has reached 100% of its full charge during an “off-peak” period, controller 26 will cause AC charger 18 to disconnect, and toggle switch 30 to switch from position “2” to position “1” to connect battery 12 to power load 32 (i.e. changing from State C to State A).

Power system 10 therefore gives preference to green power by providing power generated by renewable sources to load 32 as long as the SOC of battery 12 remains at or above 60% of its full charge, and only draws power from the grid if the SOC of battery 12 falls below 60%. Further, power system 10 will cause battery 12 to be charged by line voltage from the grid only if the SOC of battery 12 is below 60% during an off-peak period.

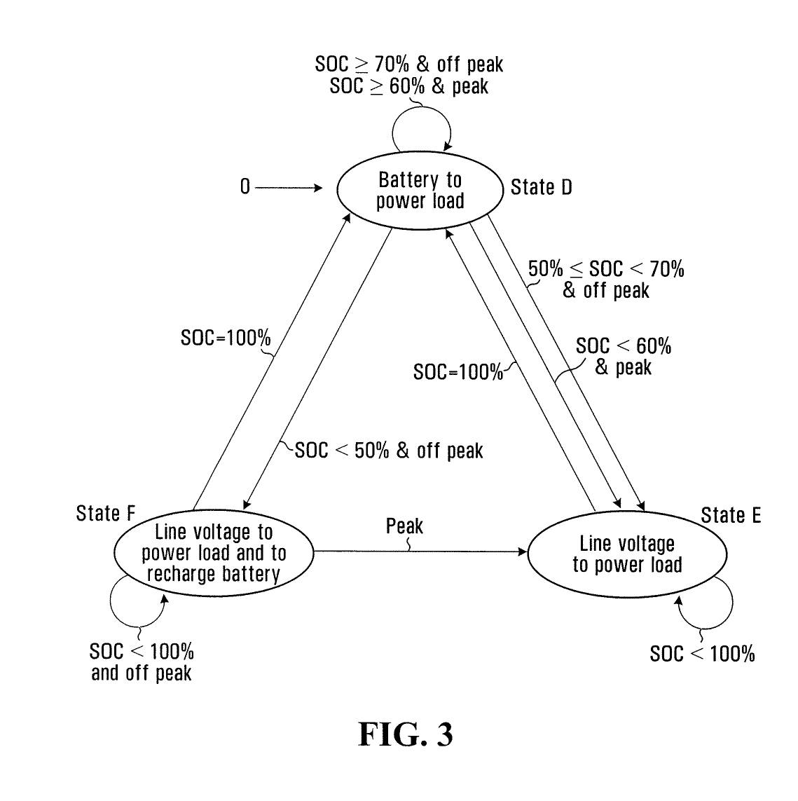

Turning to FIG. 3, which is a state diagram of a second load shifting embodiment, three states are shown: State D where battery 12 is providing power to load 32; State E where line voltage is providing power to load 32; and State F where line voltage is providing power to load 32 and charging battery 12 simultaneously. Upon powering up, power system 10 enters State D if either one of the following two conditions are met: (i) the SOC of battery 12 is equal to or greater than 70% of full charge and the time is off-peak, or (ii) the SOC of battery 12 is equal to greater than 60% of full charge and the time is peak. Power system 10 will enter State E on powering up if either one of the following two conditions are met: (iii) the SOC of battery 12 is less than 70% of full charge and equal to or greater than 50% of full charge and the time is off-peak, or (iv) the SOC of battery 12 is less than 60% of full charge and the time is peak. Power system 10 will enter State F on powering up under one condition only: if the SOC of battery 12 is less than 50% of full charge and the time is off-peak.

To illustrate the load shifting aspect of the second embodiment, suppose power system 10 is in State D. The battery 10 will provide power to load 32 as long as the SOC of battery 12 remains at or above 70% during off-peak periods, or SOC of battery 12 remains at or above 60% during peak periods. If SOC of battery 12 drops below 70% but remains at or above 50% during off-peak periods, or if SOC of battery 12 drops below 60% during peak periods, power system 10 will change from State D to State E such that line voltage will be connected to power load 32 and battery 12 will be disconnected from load 32. Power system 10 will remain at State E until the SOC of battery 12 reaches 100%, whether the time is peak or off-peak, at which time power system 10 will change from State E to State D by disconnecting line voltage from load 32 and connecting battery 12 to provide power to load 32.

Power system 10 only enters State F under one condition: if the SOC of battery 12 is below 50% and the time is off peak. In State F, power system 10 will connect line voltage to simultaneously supply power to load 32 and charge battery 12. Power system 10 will change from State F to State D when the SOC of battery 12 reaches 100%, by disconnecting line voltage from load 32 and battery 12 and connecting battery 12 to power load 32; or from State F to State E if the SOC of battery remains below 100% and the time changes from peak to off-peak, by maintaining the supply of line voltage to load 32 while simultaneously charging battery 12.

To further illustrate how power system 10 gives effect to the changes in states as described above, referring to FIGS. 1 and 3, suppose upon powering up, power system 10 assumes State D such that battery 12 is providing power to load 32, meaning that either (i) the time is off-peak, and SOC of battery 12 is at or above 70%; or (ii) the time is peak, and SOC of battery 12 is at or above 60%. If during an “off peak” time the SOC of battery 12 drops below 70% (as indicated by SOC monitor 24) or during a peak period the SOC of battery 12 falls below 60% of its full charge, controller 26 will cause toggle switch 30 to engage in position “2” to connect line voltage from the grid to power load 32 and disconnect battery 12 (i.e. changing from State D to State E). As long as the SOC of battery 12 remains below 100% toggle switch 30 will remain in position “2” to connect line voltage to power load 32. However, if the SOC of battery 12 drops below 50% during an “off-peak” period, in addition to maintaining toggle switch 30 in position “2” where line voltage powers load 32, controller 26 will further cause switch 52 to connect AC charger 18 so that the line voltage is simultaneously charging battery 12 (i.e. State F). Once the SOC of battery 12 reaches 100% of its full charge, controller will disconnect AC charger 18 and toggle switch 30 to connect to position “1” such that line voltage will no longer be connected to charge battery 12 nor to power load 32 (i.e. changing from State F to State D). Instead, battery 12 will be connected to provide power to load 32.

Further, if line voltage was powering load 32 and charging battery 12 during an “off-peak” period (i.e. State F), and the time of day changes from “off-peak” to “peak”, controller 26 will disengage AC charger 18 so that battery 12 is no longer being charged by the line voltage through AC charger 18 (i.e. change from State F to State E). However, as long as the SOC of battery 12 remains below 100% of its full charge, as indicated by SOC monitor 24, power system 10 will continue to connect line voltage to power load 32 by having controller 26 maintain switch 30 at position “2”. Once SOC monitor 24 indicates that the SOC of battery 12 has reached 100% of its full charge, controller 26 will cause toggle switch 30 to switch from position “2” to position “1” to disconnect the line voltage from the grid and connect battery 12 to provide power to load 32 (i.e. change from State E to State D).

The operation of power system 10 during “peak” periods in the second embodiment is no different than that in the first embodiment. If battery 12 is connected to provide power to load 32 it will remain so connected as long as the SOC of battery 12 remains at or above 60%, as indicated by SOC monitor 24. Once the SOC of battery 12 falls below 60%, controller 26 will cause toggle switch 30 to connect in position “2” so that the line voltage from the grid is used to power load 32. If the time of day changes from a “peak” period to an “off-peak” period and the line voltage is already connected to supply power to load 32, controller 26 will cause the line voltage to disconnect only when the SOC of battery 12 reaches 100% of its full charge, as indicated by SOC monitor 24. Once the SOC of battery 12 reaches 100%, controller 26 will cause toggle switch 30 to switch to position “1” to connect battery 12 to provide power to load 32.

It is appreciated that while line voltage from the grid may, at times, be connected to power load 32 and also to charge battery 12, the renewable energy generated by the solar panels and wind turbines continues to be harvested and stored in battery 12. Battery 12 will therefore be charged by renewable energy sources as long as these sources are generating power, and in some instances will be simultaneously charged by line voltage until battery 12 reaches a requisite SOC threshold, which in this case is 100%, at which time controller 26 will switch out the line voltage charging of the battery. It will be appreciated that the requisite SOC threshold of battery 12 can be selected and varied within a range of levels without departing from the scope of the invention.

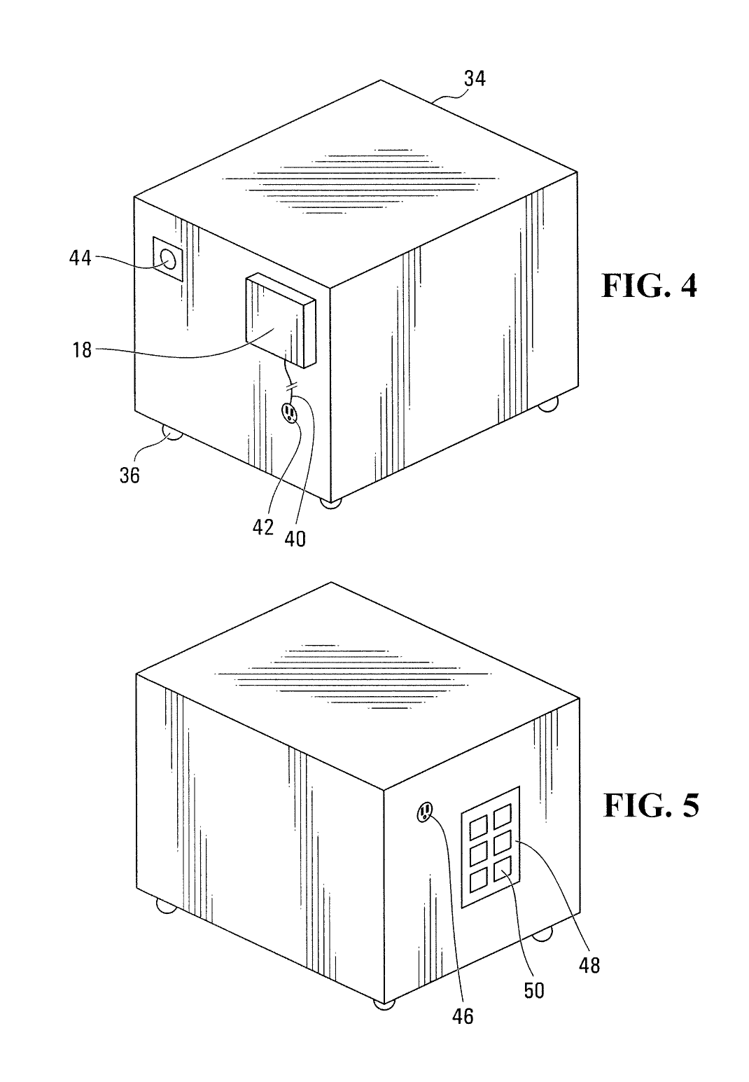

Turning to FIGS. 4 and 5, power system 10 can be enclosed in a housing 34. The housing may be made of heavy duty, weather proof, 16 gauge steel with high resistant powder coat finish. Housing 34 may optionally be fitted with wheels 36 to provide ease of transport within a particular location. Housing 34 may also be moved by a forklift.

Referring to FIG. 4, AC charger 18 is mounted on one side (input side) of housing 34. AC charger 18 has attached to it a power cord 40 with plug 42 at the end of power cord 40. Plug 42 can be used to connect to the grid through a 120V/220V electrical socket. A solar/wind input port 44 is also provided on the input side of housing 34. It is appreciated that AC charger 18 and solar/wind input port 44 can be placed in a location different than those illustrated in FIG. 4 without departing from the scope of the invention.

Referring to FIG. 5, housing 34 has an external display 48 on one side (output side). External display 48 has LED indicators 50 to indicate system parameters such as fault, battery, and load status, so the user can easily view the operation of power system 10. Also provided on the output side of housing 34 is electrical socket 46 to which load 32 can connect to draw power from power system 10. It is appreciated that external display 48 and electrical socket 46 can be placed in a location different than those illustrated in FIG. 5 without departing from the scope of the invention. Further, electrical socket 46 as illustrated may include multiple electrical sockets.

While a rechargeable battery is used in the description of the invention, it is appreciated that any rechargeable DC source could be used in place of battery 12 as, for example, a fuel cell. Further, while the described embodiment provides AC power to load 32, it is appreciated that power system 10 may also be used to provide DC power to a load by inserting a rectifier 21 (AC to DC converter) in the line voltage input to switch 30 and omitting inverter 20 at the output of the battery. Further, load 32 as indicated in FIG. 1 may in fact be multiple loads.

The present invention has many advantages, including the use of renewable energy sources to provide power to a load as the primary source of power, relying on grid power only as a back-up when the storage of the power generated by the renewable source falls below a predefined threshold. Additionally, the power system disclosed herein can be a mobile, self-contained system that is scalable to meet virtually any power requirements. The power system has many industrial applications, and can be used to provide power for general residential applications such as for an air conditioning system, and to provide power in remote areas, such as for remote shelters for telecommunications. Further, the power system can be used as a portable power generator and storage plant. The mobility of the power system lends itself to many applications. The power system can be easily transported on wheels around a site where wind turbines and solar panels are installed. Alternatively, the power system can be mounted on a wall to save space. The power system is easy to use and provides the user with a simple “plug and play” operation.

Although the present invention has been described in detail with reference to the two embodiments disclosed, other embodiments are possible. For example, other forms of renewable energy sources can be used in addition to, or in place of, solar panels and wind turbines. Generators can be used to provide back-up power in place of the grid to provide a true stand-alone system, which may be applicable in remote areas where grid power is unavailable.

Other modifications will be apparent to those skilled in the art and, therefore, the invention is defined in the claims.

What is claimed is:

1. A system for powering a load, comprising:
a battery;
a DC input to said battery for connection to a source of renewable DC power for charging said battery;
an AC charger with a DC output connected to a DC input to said battery for charging said battery and an AC input for connection to a source of AC power;
a state of charge monitor for monitoring a state of charge of said battery;
a clock;
a toggle switch for connecting one and only one of said battery and said source of AC power to said load;
one of an AC to DC converter connected between said source of AC power and said toggle switch and a DC to AC converter connected between said battery and said toggle switch;
a controller input by said state of charge monitor and said clock and outputting a switch control signal to said toggle switch and a control signal to said AC charger;
said controller for, on determining said clock indicates an off-peak time for said source of AC power, controlling said toggle switch to switch in said source of AC power and to switch out said battery only if said state of charge of said battery is below a threshold value.

2. The system of claim 1 wherein said controller is also for, on determining said clock indicates an off-peak time for said source of AC power, activating said AC charger if said state of charge of said battery is below said threshold value.

3. The system of claim 2 wherein said threshold value is about 60% of a full charge of said battery.

4. The system of claim 2 wherein said controller is also for, after controlling said toggle switch to switch in said source of AC power and to switch out said battery, on sensing a state of charge at about full charge, controlling said toggle switch to switch out said source of AC power and to switch in said battery.

5. The system of claim 2 wherein said controller is also for, on determining said clock indicates a peak time for said source of AC power, controlling said toggle switch to switch in said source of AC power and to switch out said battery only if said state of charge of said battery is below said threshold value.

6. The system of claim 2 wherein said controller is also for, after controlling said toggle switch to switch in said source of AC power and to switch out said battery and activating said AC charger, on determining said clock indicates a peak time for said source of AC power, de-activating said AC charger.

7. The system of claim 1 wherein said threshold value is a first threshold value and wherein said controller is also for, on determining said time indicated by said clock indicates said off-peak time for said source of AC power, controlling said toggle switch to switch in said source of AC power and to switch out said battery and for simultaneously activating said AC charger if said state of charge of said battery is below a second threshold value, said second threshold value being lower than said first threshold value.

8. The system of claim 7 wherein said first threshold value is about 70% of a full charge of said battery and wherein said second threshold value is about 50% of said full charge of said battery.

9. The system of claim 7 wherein said controller is also for, on determining said clock indicates a peak time for said source of AC power, controlling said toggle switch to switch in said source of AC power and to switch out said battery only if said state of charge of said battery is below a third threshold value, said third threshold value being between said first threshold value and said second threshold value.

10. The system of claim 7 wherein said controller is also for, after controlling said toggle switch to switch in said source of AC power and to switch out said battery and activating said AC charger, on determining said clock indicates a peak time for said source of AC power, de-activating said AC charger.

11. The system of claim 1 further comprising at least one of a solar panel and wind turbine with an electrical output connected to said DC input of said battery.

12. The system of claim 1 further comprising a housing for housing said battery, said DC input to said battery, said AC charger, said state of charge monitor, and said controller.

13. The system of claim 12 wherein said housing is wheeled.

14. A method of powering a load, comprising:
charging a battery from at least one renewable DC power source;
powering a load with said battery;
monitoring a state of charge of said battery;
at a beginning of each off-peak time for an electrical grid, switching in a source of AC power to power said load and ceasing to power said load with said battery only if said state of charge of said battery is below a threshold value.

15. The method of claim 14 further comprising, when charging said battery from said electrical grid, powering said load from said electrical grid and not powering said load with said battery.

16. The method of claim 15 further comprising, at said beginning of each off-peak time for said electrical grid, activating said AC charger if said state of charge of said battery is below said threshold value.

17. The method of claim 16 wherein said threshold value is about 60% of a full charge of said battery.

18. The method of claim 15 wherein said threshold value is a first threshold value and further comprising, at said beginning of each off-peak time for said electrical grid, switching in a source of AC power to power said load and ceasing to power said load with said battery and simultaneously charging said battery from said electrical grid if said state of charge of said battery is below a second threshold value, said second threshold value being lower than said first threshold value.

19. The method of claim 18 wherein said first threshold value is about 70% of a full charge of said battery and said second threshold value is about 50% of said full charge of said battery.

20. The method of claim 15 further comprising, when powering said load with said source of AC power, on sensing a state of charge of said battery at about full charge, powering said load with said battery and ceasing to power said load with said source of AC power.
